(19) United States
(12) Patent Application Publication
(10) Pub. No.: US 2003/0182126 A1
(43) Pub. Date: Sep. 25, 2003

(54) Internet advertisement system and method in connection with voice humor services

(76) Inventor: Chai-Mok Ryoo, Seoul (KR)

Correspondence Address: GREENBLUM & BERNSTEIN, P.L.C., 1950 ROLAND CLARKE PLACE, RESTON, VA, 20191, US

(21) Appl. No.: 10/296,241

(22) PCT Filed: May 23, 2001
(86) PCT No.: PCT/KR01/00852

(30) Foreign Application Priority Data
Jun. 7, 2000 (KR) 2000-30942
Nov. 4, 2000 (KR) 2000-65343
Mar. 9, 2001 (KR) 2001-12158
May 16, 2001 (KR) 2001-26624

(51) Int. Cl. G10L 11/00

(52) U.S. Cl. 704/270.1

(57) ABSTRACT

Disclosed are an Internet advertising system and a method connected to voice humor services. According to the invention, Internet advertisement is executed in the form of connecting voice humor with image advertisement or a web page. The invention achieves improved advertising effects by displaying advertiser's image advertisement or by inducing Internet user to visit an advertiser's site while an Internet user listens to voice humor lasting about 10 seconds to 4 minutes. The invention has advantages of providing image advertisement on a full screen for a relatively longer period of time than the conventional advertisement using banners or E-mails. Voice humor has characteristics of targeting a wide range of consumers, being easily and quickly changed according to its fashion, and disappearing instantly its effect after being listen to. Therefore, voice humor can induce a great number of clicking and attract still more Internet users to the advertiser's site.

### TECHNICAL FIELD

The present invention relates in general to an Internet advertising system and method connected with voice humor services, and more particular, to a method for displaying an advertisement image of an advertiser while an Internet user listens to voice humor, or for attracting visitors into an advertiser's site by displaying a web page of the advertiser's site while an Internet user listens to voice humor.

### BACKGROUND ART

Conventional Internet advertising methods mainly use banners or E-mails. For a banner advertisement, a banner containing attractive contents such as animation is inserted into a home page of an Web site. If the banner is clicked on by a user, more detailed advertisement contents are displayed or the user is connected to the advertiser's site. Meanwhile, in order to attract Internet users, premiums or a certain amount of cyber money is offered whenever the banner is clicked on. An E-mail advertisement mainly attempts to induce members to view it while providing a variety of incentives or useful contents to increase its advertising effect.

However, the conventional banner advertising method or E-mail advertising method has a drawback of being restricted to a narrow space that is dedicated for advertisement images inserted into the contents of an Web page or E-mail. Further, overlapping with other kinds of advertisements makes it difficult for an advertisement to draw users' attention. In addition, lack of motive to click on an advertisement makes it difficult to sustain continuous advertising effect. Such problems are proved by very low rates of clicking on banner advertisements and the subsequent poor results in inducing Internet users to visit the respective advertisers' sites. Methods used to solve these problems and to provide a motive for clicking on a banner advertisement include offering premiums or a certain amount of cyber money. However, such methods also fail to ensure steady advertising effects.

### DISCLOSURE OF INVENTION

It is, therefore, an object of the present invention to provide an advertising system and method on the Internet connected to voice humor services which can connect voice humor, which serves to attract frequent clicking by numerous Internet users on a steady basis due to its effect of instantly fading away after being listened to, to an advertisement image or a Web page of an advertiser's site, so as to lengthen a period of time an advertisement is viewed and expand a viewing space of the advertisement to the entire screen, unlike conventional advertisements using banners or E-mails, as well as to induce many more Internet users to visit the advertiser's site on a steady basis than the conventional advertisements using banners.

### BRIEF DESCRIPTION OF DRAWINGS

The above and other objects, features and advantages of the present invention will become more apparent from the following detailed description when taken in conjunction with the accompanying drawings, in which:

FIG. 1 is a block diagram illustrating a construction of an Internet advertising system according to a first embodiment of the present invention;

FIG. 2 is a block diagram illustrating a construction of the Internet advertising system according to a second embodiment of the present invention;

FIG. 3 is a block diagram illustrating a construction of the Internet advertising system according to a third embodiment of the present invention;

FIG. 4 is a block diagram illustrating a construction of the Internet advertising system according to a fourth embodiment of the present invention;

FIG. 5 is a flowchart illustrating an Internet advertising method according to the first embodiment of the present invention;

FIG. 6 is a flowchart illustrating an Internet advertising method according to the second embodiment of the present invention;

FIG. 7 is a flowchart illustrating an Internet advertising method according to the third embodiment of the present invention;

FIG. 8 is a flowchart illustrating an Internet advertising method according to the fourth embodiment of the present invention;

FIG. 9 is an exemplary diagram illustrating an arbitrary portion, in which link information is set according to the present invention;

FIG. 10 is an exemplary diagram illustrating a web page of an advertiser's site according to the present invention;

FIG. 11 is an exemplary diagram illustrating an advertising web page according to the present invention; and

FIG. 12 is an exemplary diagram illustrating a reproduction of a file having a combination of voice humor and an advertisement image according to the present invention.

### BEST MODE FOR CARRYING OUT THE INVENTION

Preferred embodiments of the present invention will be described herein below with reference to the accompanying drawings. In the following description, well-known functions or constructions are not described in detail since they would obscure the invention with unnecessary detail.

In the first place, I mentioned the “a site desired by an advertiser” in earlier application (KR 2000-30942 filed Jun. 7, 2000) of the present invention. The “a site desired by an advertiser” include an advertiser's site. The advertiser's site has the purpose of attracting visitors. On the other hand, I mentioned the “a site carrying out advertisements on the Internet” in another earlier application (KR 2000-65343 filed Nov. 4, 2000) of the present invention. The “a site carrying out advertisements on the Internet” include an advertiser's site and a site carrying out advertisements by using an advertising Web page including an advertisement image. The advertiser's site has the purpose of attracting visitors.

When inducing Internet users to visit a Web page of an advertiser's site(or to an advertising Web page), a separate sub-Web page may be used as an intermediary lick and may be included in a Web page of the “a site carrying out advertisements on the Internet”. This is apparent from the description made in the aforementioned application (KR 2000-65343 filed Nov. 4, 2000).

The contents used in the present invention may be voice humor, an advertisement image, or a file having a combination of the two.

The voice humor here means a file comprising voice humor of a length of about 10 seconds to four minutes. The voice humors (e.g., a series of jokes about stupid sparrows, absurd verses composed of three lines, mimicking of particular voices, talk show excerpts, etc.) are collected from comedians, those gifted with a sense of humor, TV, radio, etc. and made into voice humor files.

The advertisement image here means contents of an advertisement comprising visual materials such as characters, images, animation, motion pictures, etc. of an advertiser.

The file having a combination of voice humor and an advertisement image is a file(e.g., an *.asf file) made in the form of a single file by editing and combining a voice humor file with an advertisement image file (comprising characters, images, animation, motion pictures, etc.) through a variety of editing tools(e.g., Windows Media Author, Flash, or Premiere).

The file is then stored in a server so that voice humor is outputted at the same time while the advertisement image is displayed when reproducing the file having the voice humor/advertisement image combination stored in the server. Meanwhile, the file having a combination of voice humor and an advertisement image must be distinguished from a file (e.g., an *.html file, an *.smil file) integrally controlling a voice humor file (e.g., real audio, etc.) and an advertisement image file (e.g., real picks, etc.) that are respectively stored in a server.

The file having a combination of voice humor and an advertisement image can be inserted in a web page.

The voice humor, the advertisement image, and the file having the voice humor/advertisement image combination as used in the present invention are stored and managed in a file format. The file format can be classified into a file that can be streamed upon being downloaded, and a file that can be reproduced after being downloaded.

Here, the voice humor file does not require so high sound quality as music. Further, a size thereof can be drastically reduced by narrowing the sound range and by making the file to be mono instead of stereo owing to the relatively short length thereof. Therefore, the voice humor file per se rather than a compressed file such as in streaming format may be used in a very high speed network that has become popular in recent days. However, an ordinary voice humor file(or a file having a combination of voice humor and an advertisement image) is preferably transmitted and reproduced in real time by means of streaming due to the great size thereof. Also, most of the streamable files may be reproduced after being downloaded rather than by means of streaming due to its highly compressed nature.

A player for reproducing voice humor, an advertisement image, or a file having a voice humor/advertisement image combination may be an applicable program that is separately plugged in. In case of a file format supported by a Web browser(e.g., wav or jpg, etc.), however, the Web browser can perform the function of a player as well. In particular, it would be more preferable to use a file made in a format of motion picture advertisements or an ultra-slim wav file that has been produced by means of a rich media technology of Miralnet (http://www.miralnet.com) to take advantages of a drastically reduced size as well as of dispensing with a separate plug-in in terms of a user interface.

The www service, which is based on HTTP(hyper text transmission protocol) and provided by exchanging documents described in HTML(hyper text markup language), the streaming technology, which is related to real time transmission and mainly used in Internet broadcasting, and the technology combining voice humor with an advertisement image by means of diverse tool programs are technologies widely used. Therefore, no detailed description thereof will be provided herein.

According to the present invention, connecting a Web page of an advertiser's site (or an advertising Web page) with voice humor means connecting the two so as to reproduce voice humor while the Web page of the advertiser's site(or the advertising Web page) is displayed through link information set in an arbitrary portion.

For example, there are a method of inserting voice humor in a web page of an advertiser's site(or an advertising web page), and a method of reproducing voice humor in a window, which is different from the one where a Web page of an advertiser's site(or an advertising web page) is displayed, on the basis of a computer's multitasking.

Here, the insertion of voice humor in a web page means that link information comprising a file name and an Internet address of a voice humor server, in which the voice humor is stored, is included in the Web page by using a tag(e.g., embed, object, or bgsound tag).

The request for receiving the voice humor inserted (or connected) in a Web page can be classified into a case that the request is automatically made by a browser when the Web page is displayed, and a case that the request is made by a user who clicks on or points to reproduction means that has been transmitted together with the Web page.

When produced in a format not supported by a browser, the voice humor is connected to a Web page through a plug-in or an ActiveX control. Thus, when reproducing the voice humor inserted in the Web page, the related plug-in program does not appear on the screen. At this stage, it is necessary to install a plug-in, which can reproduce a file of a related format, in a computer of the Internet user.

On the other hand, reproducing voice humor in a window different from the one where a Web page of an advertiser's site (or an advertising web page) is displayed can be classified into a method of including a tag or a language such as Java scripts for requesting the web page of an advertiser's site (or the advertising web page) in a separate sub-web page, in which voice humor has been inserted, so that the Web page of an advertiser's site (or the advertising web page) can be opened in a different window in accordance with the request generated due to opening of the sub-web page, in which the voice humor has been inserted, by the link information provided in an arbitrary portion of the screen; and a method of using a tag or a language such as a Java script so that two requests for reception of both the web page of an advertiser's site (or the advertising web page) and the voice humor (or the sub-web page in which the voice humor has been inserted) can be generated from an arbitrary potion of the screen. Here, if the arbitrary portion is provided by a web page, this web page may function as the sub-web page, in which the voice humor is inserted. In other words, the voice humor is reproduced in the Web page providing the arbitrary portion, and the Web page of the advertiser's site (or the advertising web page) is displayed on a separate window.

The technology described above so that two requests for reception are generated from an arbitrary portion by using a tag or a language such as Java script is a technology well-known at the tine of filing earlier application of the present invention, and is an obvious matter that can be easily assumed by a person skilled in the pertinent art in view of the description made in earlier application of the present invention.

Meanwhile, a Web page of an advertiser's site connected to voice humor preferably includes navigation means that is movable within the advertiser's site, and needs to be distinguished from a link or connection for simply providing the voice humor of the advertiser's site.

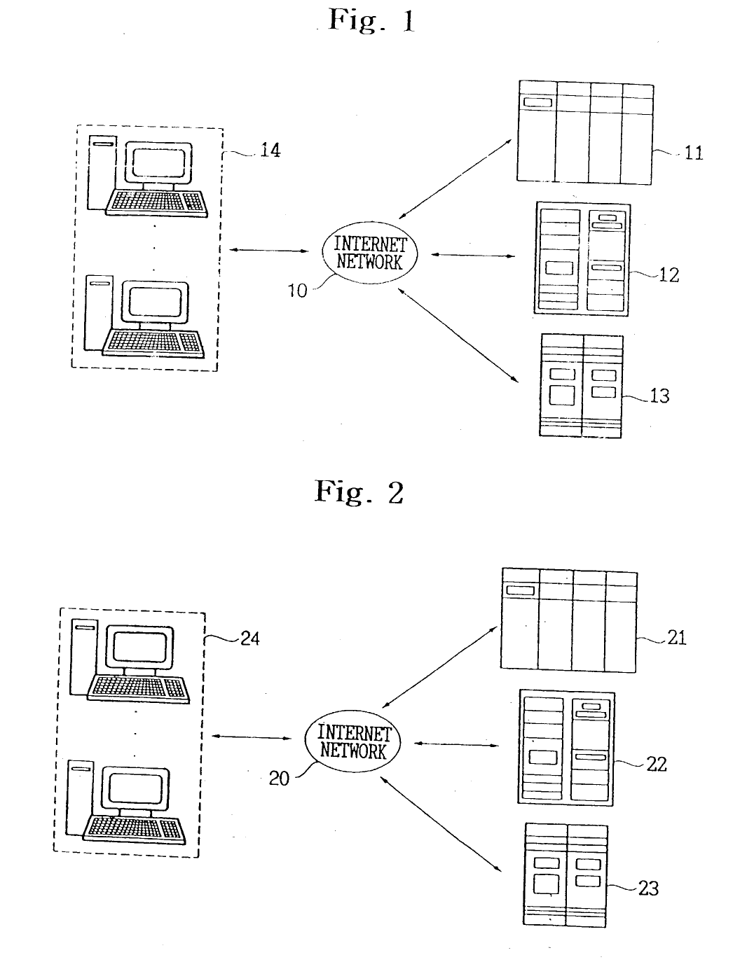

FIG. 1 is a block diagram illustrating a construction of an Internet advertising system according to a first embodiment of the present invention.

Referring to FIG. 1, the Internet advertising system according to the first embodiment of the present invention comprises: a voice humor server 11 including voice humor and a program related thereto; an advertiser's site (Web server) 12 including a Web page connected to the voice humor; an arbitrary server 13 including an arbitrary portion for providing link information to request the voice humor and a Web page of the advertiser's site; and an Internet user's computer 14 connected to an Internet network 10 and including a related reproduction program.

The voice humor server 11 may preferably include a database or file system for storing the voice humor in the form of a file and providing the stored voice humor to the user's computer 14, and a streaming-related program in accordance with a format of the voice humor file for transmitting the voice humor in real time by means of the streaming technology. The advertiser's site (Web server) 12 means an advertiser's site having the purpose of attracting visitors. The arbitrary server 13 represents an arbitrary portion on the Internet that provides link information to request voice humor and a Web page of the advertiser's site (or an advertising Web page) The voice humor, the Web page of the advertiser's site and the arbitrary portion are connected.

The Internet user's computer 14, which generally refers to a computer connectable to the Internet, includes an Internet TV and wireless Internet terminal, which have substantially the same function as a computer connectable to the Internet, and a program for reproducing a file made in a format as transmitted from the server.

FIG. 1 illustrates the voice humor server 11 and the advertiser's site (Web server) 12 on a separate basis. However, the voice humor may be stored and provided in a file system or database of the advertiser's site (Web server) 12. In that case, the voice humor server 11 and the advertiser's site (Web server) 12 may exist in a single computer. It would be obvious to those skilled in the art that separation of the voice humor server 11 from the advertiser's site (Web server) 12 is not based on a physical concept but on a functional perspective.

The first embodiment of the present invention is operated in such a manner that, if the arbitrary portion providing the link information is clicked on or pointed to by an Internet user who is connected to the arbitrary server 13 on the Internet, the advertiser's site 12 transmits a Web page of the advertiser's site, and the voice humor server 11 transmits voice humor. The Internet user listens to voice humor outputted through speakers that are attached to his/her own computer 14 while the Web page of the advertiser's site 12 is displayed.

Therefore, while the Internet user listens to the voice humor outputted from the speakers, the advertiser's site 12 on the Internet can attract the Internet user.

FIG. 2 is a block diagram illustrating a construction of the Internet advertising system according to a second embodiment of the present invention.

Referring to FIG. 2, the Internet advertising system according to the second embodiment of the present invention comprises: a voice humor server 21 including voice humor and a program related thereto; an Internet site (Web server) 22 including an advertising Web page connected to the voice humor; an arbitrary server 23 including an arbitrary portion for providing link information to request the voice humor and the advertising Web page; and an Internet user's computer 24 connected to an Internet network 20 and including a related reproduction program.

Here, the voice humor server 21, the arbitrary server 23 and the Internet user's computer 24 are of the same nature as described with reference to FIG. 1. The Internet site (Web server) 22 provides an advertising Web page including an advertisement image. The voice humor, the advertising Web page, and the arbitrary portion are connected. Also, as described above, the voice humor server 21 and the Internet site (Web server) 22 may exist in a single computer.

The second embodiment of the present invention is operated in such a manner that, if the arbitrary portion providing the link information is clicked on or pointed to by an Internet user who is connected to the arbitrary server 23 on the Internet, the Internet site (Web server) 22 transmits an advertising Web page, and the voice humor server 21 transmits voice humor. As a consequence, the Internet user listens to voice humor outputted through speakers that are attached to his/her own computer 24 while the advertising Web page is displayed.

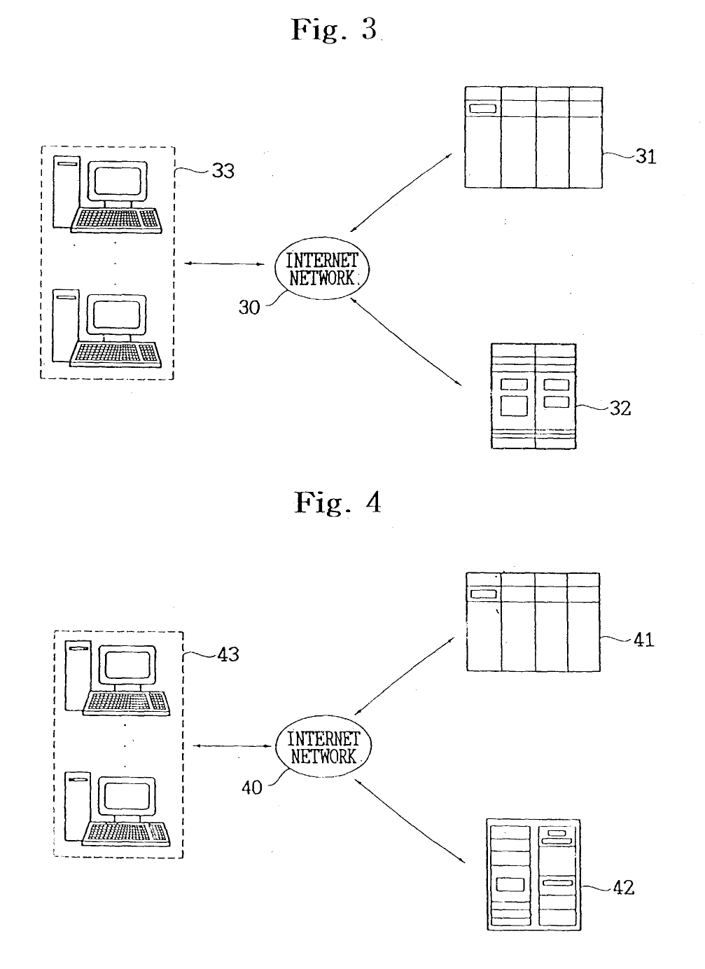

Therefore, an advertising effect is achieved by the advertisement image displayed on the advertising Web page while the Internet user listens to the voice humor outputted from the speakers FIG. 3 is a block diagram illustrating a construction of the Internet advertising system according to a third embodiment of the present invention.

Referring to FIG. 3, the Internet advertising system according to the third embodiment of the present invention comprises a voice humor server 31 including a file having a combination of voice humor and an advertisement image, and a program related thereto; an arbitrary server 32 including an arbitrary portion for providing link information to request the file with the voice humor/advertisement image combination; and an Internet user's computer 33 connected to an Internet network 30 and having a related reproduction program.

Here, the voice humor server 31, the arbitrary server 32, and the Internet user's computer 33 are of the same nature as described with reference to FIG. 1. The file with the voice humor/advertisement image combination, and the arbitrary portion are connected.

The third embodiment of the present invention is operated in such a manner that, if the arbitrary portion providing the link information is clicked on or pointed to by an Internet user who is connected to the arbitrary server 32 on the Internet, the voice humor server 31 transmits a file having a combination of voice humor and an advertisement image. The Internet user's computer 33 loads the transmitted file into a related player and then reproduces it through the player. As a consequence, the advertisement image is displayed by the player while the voice humor is outputted through speakers. Therefore, an advertising effect is achieved by the advertisement image displayed on the player while the Internet user listens to the voice humor outputted from the speakers.

FIG. 4 is a block diagram illustrating a construction of the Internet advertising system according to a fourth embodiment of the present invention.

Referring to FIG. 4, the Internet advertising system according to the fourth embodiment of the present invention comprises a voice humor server 41 including voice humor and a program related thereto; an advertising server 42 including an advertising Web page, in which the voice humor has been inserted; and an Internet user's computer 43 connected to an Internet network 40 and having a related reproduction program. Here the voice humor server 41 and the Internet user's computer 43 are of the same nature as described with reference to FIG. 1. The advertising server 42 refers to a server for transmitting an advertising Web page either by means of a database of a particular recipient or via an E-mail server. Voice humor is inserted in the advertising Web page.

The fourth embodiment of the present invention is operated in such a manner that, the advertising server 42 on the Internet transmits the advertising Web page, in which voice humor has been inserted, to particular E-mail recipients via E-mail. While the advertising Web page is displayed on an E-mail recipient's computer 43, the voice humor transmitted from the voice humor server 41 is reproduced and outputted from the speakers. As a consequence, while the E-mail recipient views the advertisement image displayed on the advertising Web page, the E-mail recipient listens to the voice humor outputted from the speakers attached to his/her own computer 43.

Thus, an advertising effect is achieved by the advertisement image displayed on the advertising Web page while the E-mail recipient listens to the voice humor outputted from the speakers.

Here, the advertising Web page is generally transmitted to the recipient's computer 43 via a mail server of the recipient's account.

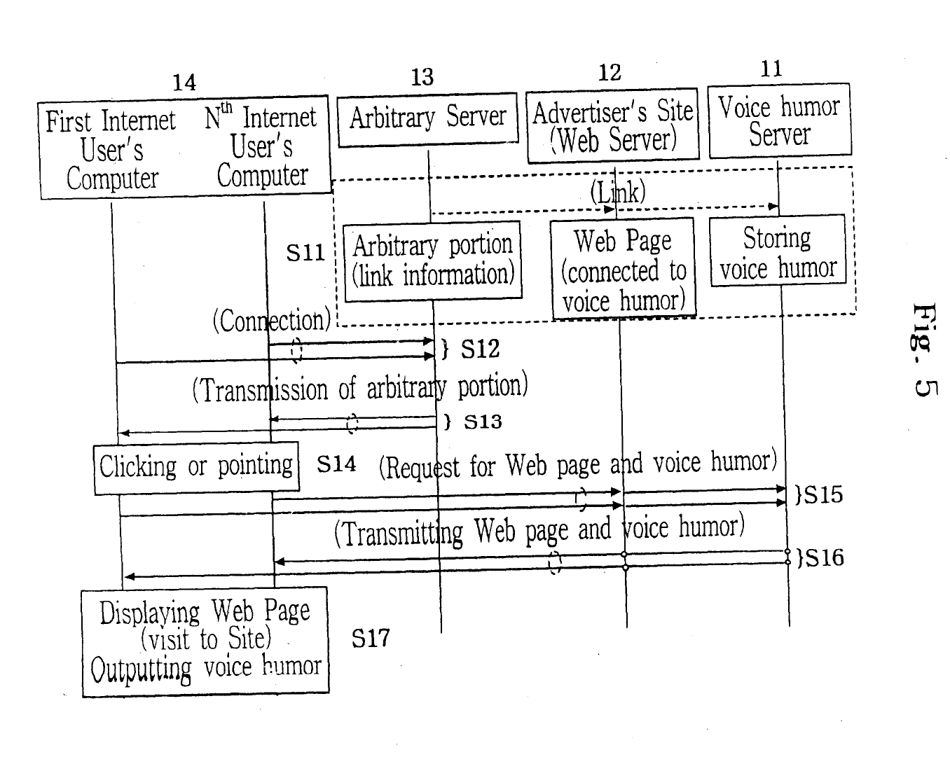

FIG. 5 is a flowchart illustrating an Internet advertising method according to the first embodiment of the present invention.

Referring to FIG. 5, voice humor is stored in a database or a file system of the voice humor server 11 connected to the Internet. Subsequently, a Web page of the advertiser's site 12 on the Internet is connected to the voice humor stored in the voice humor server 11. Then, link information to request the Web page and the voice humor is set in an arbitrary portion on the Internet (S11). Indicating the output of the voice humor on the arbitrary portion at this stage will serve to attract more clicking. Since the database or the file system is one widely used, no further description will be given here in relation thereto.

Meanwhile, each Internet user connects his/her own computer 14 to the arbitrary server 13 on the Internet including the arbitrary portion (S12). Then, the arbitrary server 13 transmits the arbitrary portion to the Internet user's computer 14 connected thereto (S13). Each Internet user then requests transmission of the Web page of the advertiser's site and the voice humor by clicking on or pointing to the arbitrary portion appearing on his/her own monitor (S14). The request is subsequently transmitted to the advertiser's site 12 and voice humor server 11 on the Internet (S15).

The advertiser's site 12 and voice humor server 11 on the Internet respectively transmit the requested Web page and voice humor to the Internet user's computer 14 (S16).

While each Internet user's computer 14 displays the Web page of the advertiser's site, the voice humor is reproduced and outputted through speakers (S17). As a consequence, the Internet user attracted to the voice humor is connected to the Web page of the advertiser's site 12 on the Internet, and listens to the voice humor while visiting the advertiser's site.

At this stage, the Web page of the advertiser's site is preferably a home page (initial page) of the advertiser's site. Another step may be added to request the voice humor by using separate means included in the Web page of the advertiser's site and transmitted along therewith.

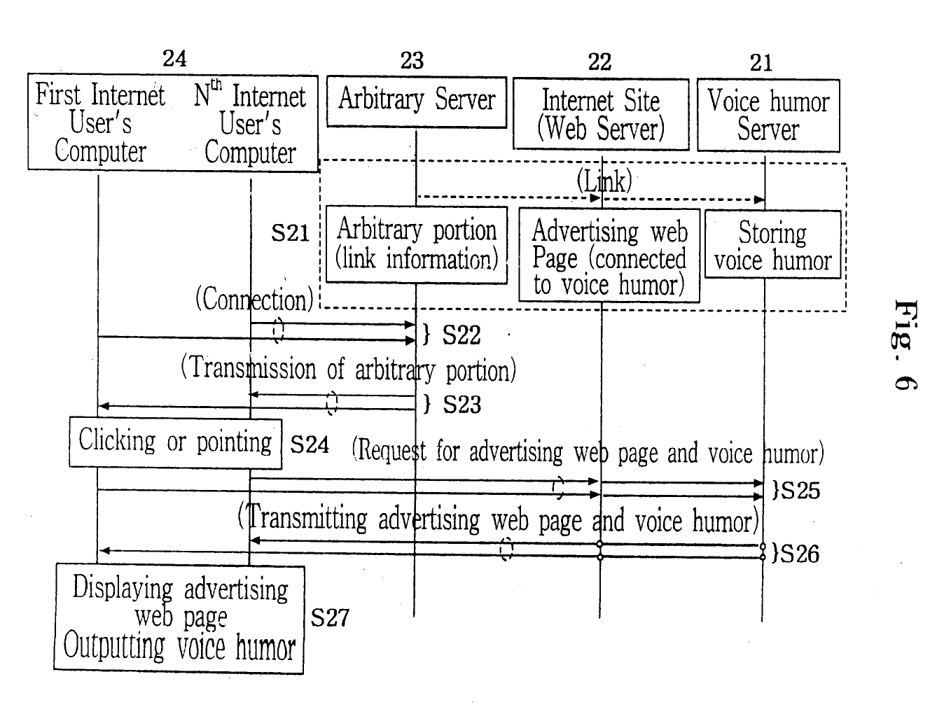

FIG. 6 is a flowchart illustrating an Internet advertising method according to the second embodiment of the present invention.

Referring to FIG. 6, voice humor is stored in a database calf a file system of the voice humor server 21 connected to the Internet. An advertising Web page is stored in an Internet site (Web server) 22 on the Internet. The advertising Web page and the voice humor stored in the voice humor server 21 are connected. Link information to request the advertising Web page and the voice humor is set in an arbitrary portion of the Internet (S21).

Meanwhile, each Internet user connects his/her own computer 24 to the arbitrary server 23 on the Internet including the arbitrary portion(S22). The arbitrary server 23 transmits the arbitrary portion to the Internet user's computer 24 connected thereto (S23). Each Internet user requests transmission of the advertising Web page and the voice humor by clicking on or pointing to the arbitrary portion appearing on his/her own monitor (S24). The request is subsequently transmitted to the Internet site (Web server) 22 and voice humor server 21 on the Internet (S25).

The Internet site (Web server) 22 and voice humor server 21 on the Internet respectively transmit the requested advertising Web page and voice humor to the Internet user's computer (S26).

While each Internet user's computer 24 displays the advertising Web page, the voice humor is reproduced and outputted through speakers (S27). As a consequence, the Internet user attracted to the voice humor is connected to the advertising Web page of the Internet site (Web server) 22 on the Internet, and listens to the voice humor while viewing the displayed advertisement image.

At this stage, another step may be added to request the voice humor by using separate means included in the advertising Web page and transmitted along therewith.

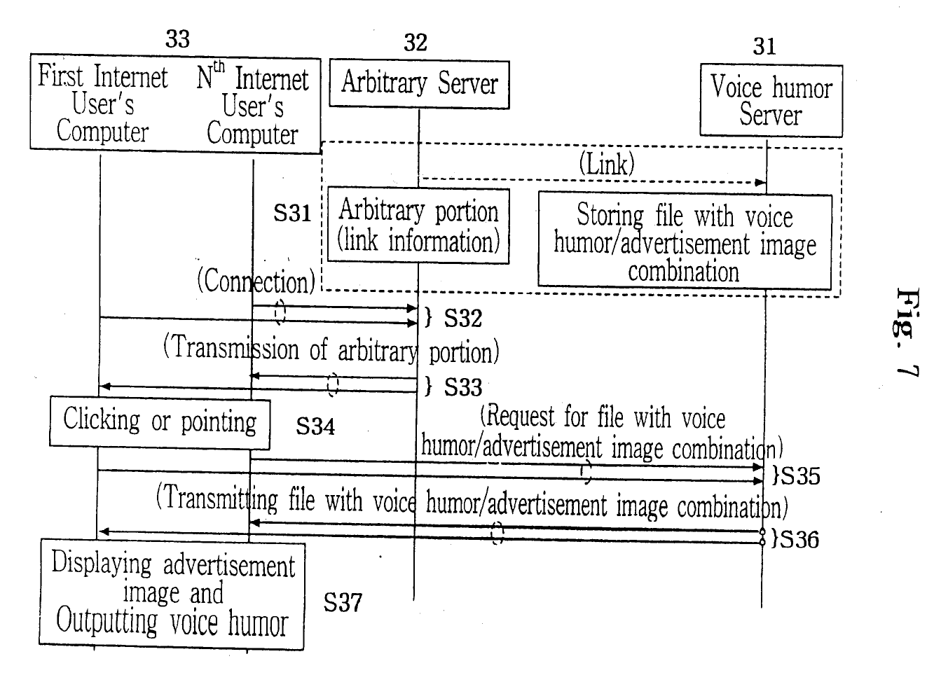

FIG. 7 is a flowchart illustrating an Internet advertising method according to the third embodiment of the present invention.

Referring to FIG. 7, a file having a combination of voice humor and an advertisement image is stored in a database or a file system of a voice humor server 31 on the Internet. Link information is set in an arbitrary portion on the Internet to request the file with the voice humor/advertisement image combination (S31).

Meanwhile, each Internet user connects his/her own computer 33 to the arbitrary server 32 on the Internet including the arbitrary portion (S32). The arbitrary server 32 transmits the arbitrary portion to the Internet user's computer 33 connected thereto (S33). Each Internet user requests transmission of the file with the voice humor/advertisement image combination by clicking on or pointing to the arbitrary portion appearing on his/her own monitor (S34) The request is subsequently transmitted to the voice humor server 31 on the Internet (S35).

The voice humor server 31 on the Internet transmits the file with the voice humor/advertisement image combination to the Internet user's computer 33 (S36).

Each Internet user's computer 33 loads the transmitted file with the voice humor/advertisement image combination into a related player and then reproduces it through the player so that the voice humor can be outputted through speakers while the advertisement image is displayed on a screen (S37). As a consequence, the Internet user attracted to the voice humor views the displayed advertisement image while listening to the voice humor.

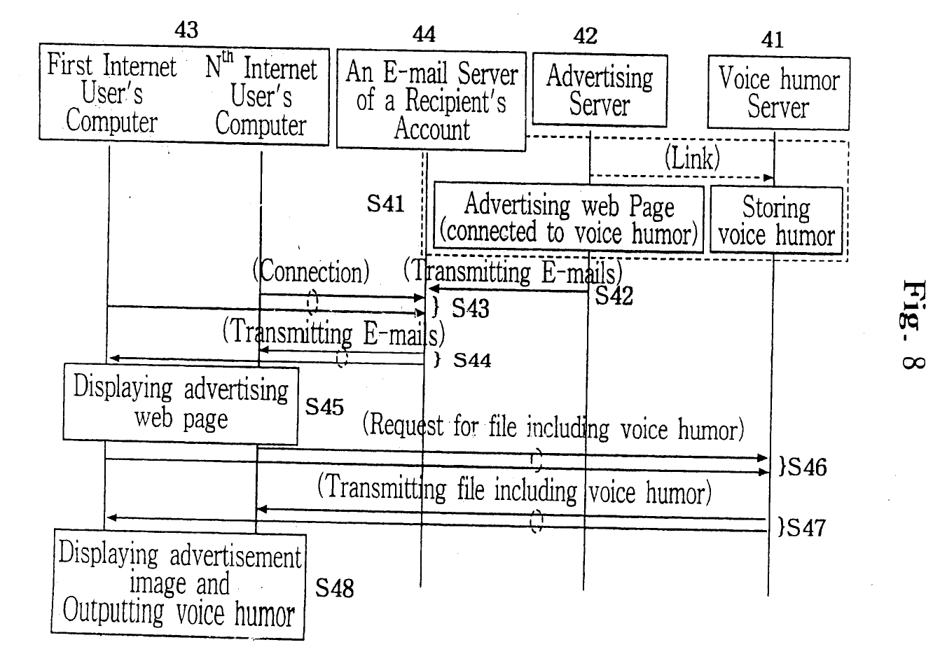

FIG. 8 is a flowchart illustrating an Internet advertising method according to the fourth embodiment of the present invention.

Referring to FIG. 8, voice humor is stored in a database or a file system of a voice humor server 41 on the Internet. The voice humor stored in the voice humor server 41 is inserted in an advertising Web page of the advertising server 42 on the Internet (S41). Meanwhile, the advertising server 42 transmits the advertising Web page, in which the voice humor has been inserted, to particular recipients via E-mail (S42). Here, it is possible to include a database of a particular recipient or to pass the advertising Web page through a separate mail server.

Each E-mail recipient connects his/her own computer 43 to the mail server 44, which has received the advertising Web page (S43) The mail server 44 transmits the advertising Web page, in which the voice humor has been inserted, to the E-mail recipient's computer 43 (S44).

The computer 43 of each E-mail recipient displays the transmitted advertising Web page (S45), and requests transmission of a file including the voice humor (a file-having only the voice humor or a file having a combination of the voice humor and an advertisement image) to the voice humor server 41 by using the inserted link information (S46). The voice humor server 41 searches the database or file system for the requested file including the voice humor, and transmits the searched file to the E-mail recipient's computer 43 (S47). While the computer 43 of the E-mail recipient displays the advertising Web page, the file including the voice humor is reproduced so that the voice humor can be outputted through speakers (S48).

Therefore, an advertising effect is achieved by the advertisement image displayed on the advertising Web page while the E-mail recipient listens to the voice humor.

Here, another step may be added to request the voice humor by using separate means included in the advertising Web page and transmitted along therewith.

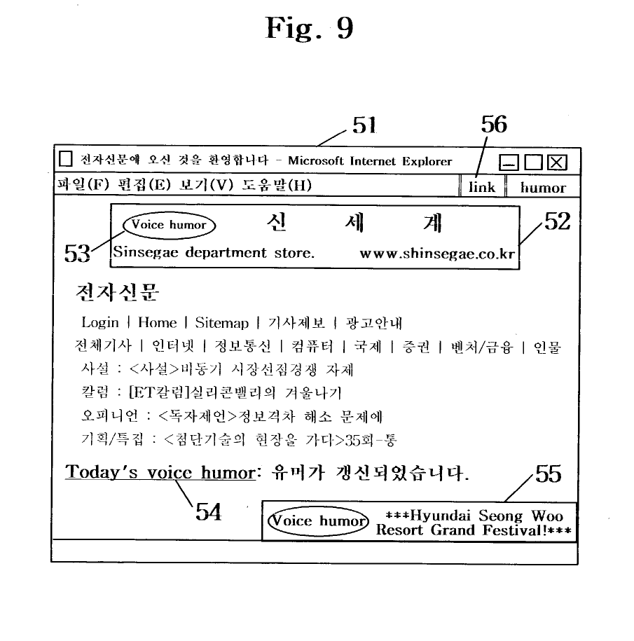

FIG. 9 is an exemplary diagram illustrating an arbitrary portion for requesting a Web page 61 of an advertiser's site, an advertising Web page 71, a file having a combination of voice humor and an advertisement image, and so on.

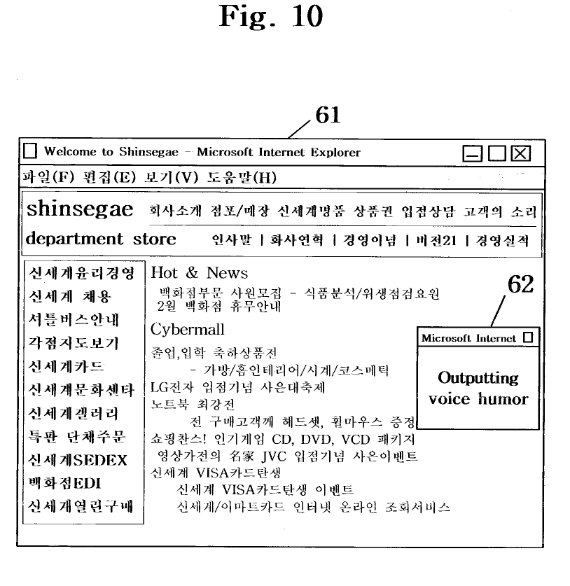

Referring to FIG. 9, a “Shinsegae” banner 52 containing an indication 53 of “voice humor”, an indication 54 of “today's voice humor”, an indication of “humor” in a connection tool box 56, and a banner containing an indication of “voice humor” pushed on an advertising window 55, which is referred to as an “ad bar”, are examples of an arbitrary portion to request the Web page 61 of the advertiser's site, the advertising Web page 71, the file with the voice humor/advertisement image combination, the voice humor, etc. To be specific, if Internet users attracted to the indication 53 of “voice humor” click on or point to the banner 52, they are connected to a Shinsegae site. As a consequence, the Internet users listen to the voice humor while the Web page 61 of the Shinsegae department store site is displayed as shown in FIG. 10. The voice humor has advantages of inducing continual clicking. Here, in case that the arbitrary portion is a banner, still more users are attracted to the voice humor and the number of clicks are increased still more. Therefore, the present invention can effectively solve the problem of conventional banner advertisements having a low rate of click.

FIG. 10 is an exemplary diagram illustrating a Web page of an advertiser's site connected to voice humor.

The Web page 61 is initial Web page of the Shinsegae department store site. The Web page (initial page) 61 of the Shinsegae department store site is connected to the voice humor stored in the voice humor server so that the voice humor transmitted by the voice humor server can be outputted through speakers while the Web page 61 is displayed. At this stage, a visitor is supposed to stay in the site until he/she has listened to the entire voice humor. Therefore, the advertiser's site can effectively advertise the site.

A small window 62 is a separate sub-web page, in which voice humor is inserted, and is an example of an intermediary Link in inducing Internet users to visit the Wet page (initial page) 61 of the advertiser's site. To be specific, the stall window 62 is opened by clicking on the link information set in the arbitrary portion. The Web page (initial page) 61 of the Shinsegae department store site is opened in a new window by a tags or a language such as Java scripts included in the small window 62. The system may be constructed to open either the Web page of the advertiser's site or the sub-Web page simultaneously with the other page. The Web page of the advertiser's site (or the advertising Web page) and the voice humor (or the separate sub-Web page, in which the voice humor is inserted) may be requested at the same time by the link information set in an arbitrary portion. This can be realized by using means such as an event handler of Java script.

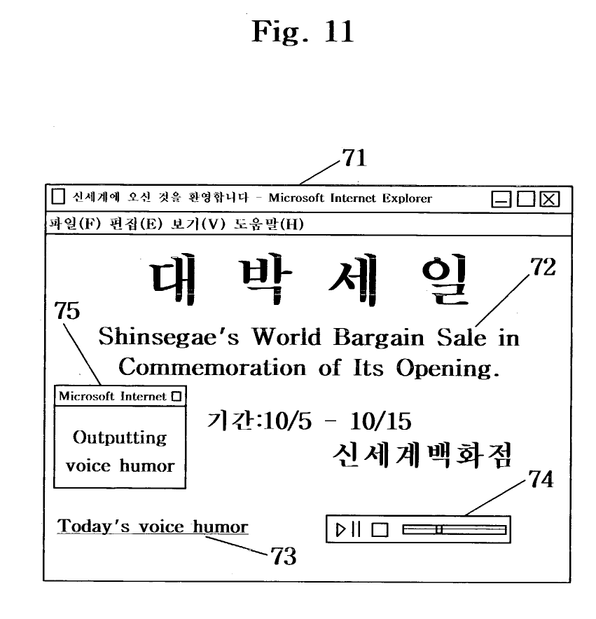

FIG. 11 is an exemplary diagram illustrating an advertising Web page connected to voice humor according to the present invention.

The advertising Web page 71 contains an announcement of bargain sales by the department store, and is connected to the voice humor stored in the voice humor server 21 so that the voice humor transmitted by the voice humor server can be outputted through speakers while the advertisement image 72 of the advertising Web page 71 is displayed. The advertisement image 72 displayed on the advertising Web page 71 may be transmitted in combination with the voice humor.

A separate user interface 74 is transmitted to the Internet user's computer along with the advertising Web page (or the Web page of the advertiser's site) 71. To be specific, the voice humor is not automatically received upon opening of the advertising Web page (or the Web page of the advertiser's site) 71 but is requested upon clicking on or pointing to the reproduction means 74 by the Internet user.

Meanwhile, the advertising Web page 71 can be transmitted to a particular recipient via E-mail. In that case, the E-mail recipient can listen to the voice humor outputted from speakers while viewing a displayed advertisement image. The E-mail recipient can also give a command to reproduce or terminate the voice humor by using the reproduction means 74 transmitted along with the advertising Web page.

A small window 75 is a separate sub-Web page, in which the voice humor has been inserted, and no further description will be made here because it is of a similar nature to the small window 62 described with reference to FIG. 10.

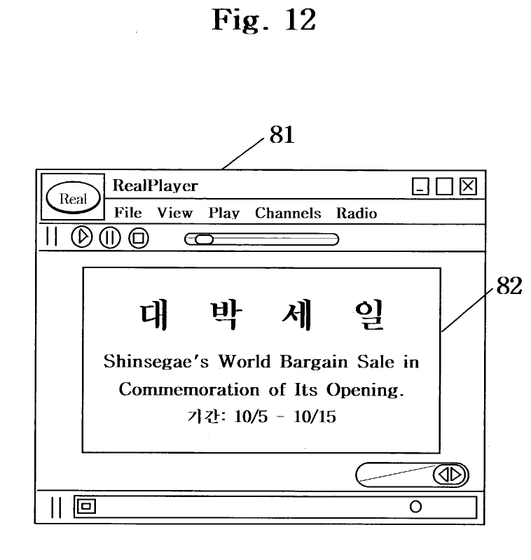

FIG. 12 is an exemplary diagram illustrating reproduction of a file having a combination of voice humor and an advertisement image.

Referring to FIG. 12, a file having a combination of voice humor and an advertisement image is reproduced by a player 81 rather than by being inserted in a Web page. In other words, the file with the voice humor/advertisement image combination, which has been transmitted by the voice humor server 31, is reproduced sea that the voice humor can be outputted through speakers while the advertisement image 82 is displayed to achieve its advertising effect.

Combining the voice humor and the advertisement image that are absolutely different elements exerts a strong synergistic effect, resulting in a new effect of advertisement.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

For example, advertisements may be effectively represented by concentrating link information set in a plurality of arbitrary portions of the Internet on a specific Internet site, constructing a database with an advertisement image of an advertiser, and displaying the advertisement image while enabling Internet users to listen to voice humor. In that case, the specific Internet site will be a site of an advertisement agency. Therefore, the present invention will not be confined to the embodiments described above.

### INDUSTRIAL APPLICABILITY

As apparent from the above description, the present invention makes available a full screen for advertisements by using voice humor, which is aural means for attracting Internet users. Furthermore, since voice humor is applied to all the people, the range of advertisements is wide. Voice humor has characteristics of targeting a wide range of consumers, being rapidly changed according to its fashion, and fading instantly after providing its effect. Therefore, continuous updating the voice humor stored in a voice humor server to arouse interest serves to induce continual clicking by Internet users. Further, provision of funny voice humor also serves to reduce annoyance at being linked to an advertiser's site or viewing an advertisement image. In addition, Internet users can be made to view an advertisement until the voice humor has completely ended. As a consequence, the advertisement can be displayed for a longer period of time. Moreover, a minor change in the contents of voice humor stored in the voice humor server greatly broadens the system's appeal to all Internet users.

The voice humor has advantages of inducing continual clicking from all walks of life without causing any negative reaction from the Internet users.

Thus, continual clicking by many more Internet users can be induced than the conventional banner advertisement commonly used for attracting Internet users to an advertiser's site. Further, an advertisement image can be displayed on an entire screen until the voice humor is completely ended Such advantages are expected to carry higher advertising effects than the conventional advertisement using banners or E-mails.

What is claimed is:

1. An Internet advertising method connected with voice humor services, the method comprising the steps of:
connecting voice humor stored in a voice humor server on the Internet with a Web page of an advertiser's site;
if an Internet user's computer requests the Web page connected to the voice humor through an arbitrary portion on the Internet according to humor link information, receiving the request in the advertiser's site;
transmitting the requested Web page to the Internet user's computer from the advertiser's site; and
outputting the voice humor transmitted from the voice humor server through speakers while visiting the advertiser's site by displaying the Web page on a screen of the Internet user's computer.

2. The method of claim 1, wherein the Web page of the advertiser's site is an initial Web page of the advertiser's site.

3. The method of claim 1, wherein the voice humor is connected to the Web page of the advertiser's site so as to be reproduced in a Web page, which is different from the Web page of the advertiser's site.

4. The method of claim 1, wherein the arbitrary portion is a banner.

5. The method of any one of claims 1 to 4, wherein the Web page of the advertiser's site is transmitted to the Internet user's computer together with means for commanding reproduction of the voice humor connected to the Web page, and a request for receiving the connected voice humor is generated by clicking on or pointing to the means for commanding reproduction.

6. An Internet advertising method connected with voice humor services, the method comprising the steps of:
connecting voice humor stored in a voice humor server on the Internet with an advertising Web page stored in an Internet site;
if an Internet user's computer requests the advertising Web page connected to the voice humor through an arbitrary portion on the Internet according to humor link information, receiving the request in the Internet site; and
transmitting the requested advertising Web page to the Internet user's computer from the Internet site;
whereby the voice humor transmitted from the voice humor server is outputted through speakers while the advertising Web page is displayed on a screen of the Internet user's computer.

7. The method of claim 6, wherein the voice humor is connected to the advertising Web page so as to be reproduced in a Web) page different from the advertising Web page.

8. The method of claim 6, wherein the arbitrary portion is a banner.

9. The method of any one of claims 6 to 8, wherein the advertising Web page is transmitted to the Internet user's computer together with means for commanding reproduction of the voice humor connected to the advertising Web page, and a request for receiving the connected voice humor is generated by clicking on or pointing to the means for commanding reproduction.

10. An Internet advertising method connected with voice humor services, the method comprising the steps of:
storing a file having a combination of voice humor and an advertisement image in a voice humor server on the Internet;
if an Internet user's computer requests the file through an arbitrary portion on the Internet according to humor link information, receiving the request in the voice humor server; and
transmitting the requested file to the Internet user's computer from the voice humor server;
whereby if the file is received by the Internet user's computer, the voice humor included in the file is outputted through speakers while the advertisement image included in the file is displayed on a window of a player having a function of reproducing the file, and the file is not an advertising Web page connected to voice humor.

11. The method of claim 10, wherein the arbitrary portion is a banner.

12. An Internet advertising method connected with voice humor services, the method comprising the steps of:
inserting voice humor stored in a voice humor server an the Internet in an advertising Web page of an advertising server; and
transmitting the advertising Web page, in which the voice humor is inserted, to specific recipients from the advertising server via E-mail;
whereby the voice humor transmitted from the voice humor server is outputted through speakers while the advertising Web page is displayed on a screen of a recipient's computer.

13. The method of claim 12, wherein the advertising Web page is transmitted to the specific recipients' computers together with means for commanding reproduction of the voice humor inserted in the advertising Web page, and a request for receiving the inserted voice humor is generated by clicking on or pointing to the means for commanding reproduction.

14. An Internet advertising system connected with voice humor services, the system comprising:
a voice humor server for providing voice humor;
an advertiser's site including a Web page connected to specific voice humor stored in the voice humor server;
an arbitrary server for providing humor link information for access to the Web page; and
an Internet user's computer connected to the voice humor server, the advertiser's site and the arbitrary server via the Internet;
whereby, if the Internet user's computer requests the Web page through the humor link information in the arbitrary server, the advertiser's site transmits the Web page to the Internet user's computer, and if the Internet user's computer requests the voice humor server to transmit the specific voice humor connected to the Web page, while it displays the Web page on its Web browser screen, the voice humor server transmits the specific voice humor to the Internet user's computer, and the voice humor is outputted through speakers while the Web page is displayed on the Web browser screen of the Internet user's computer.

15. An Internet advertising system connected with voice humor services, the system comprising:
a voice humor server for providing voice humor;
an Internet site including an advertising Web page connected to specific voice humor stored in the voice humor server;
an arbitrary server for providing humor link information for access to the advertising Web page; and
an Internet user's computer connected to the voice humor server, the Internet site and the arbitrary server via the Internet;
whereby, if the Internet user's computer requests the advertising Web page through the humor link information in the arbitrary server, the Internet site transmits the advertising Web page to the Internet user's computer, and if the Internet user's computer requests the voice humor server to transmit the specific voice humor connected to the advertising Web page, while it displays the advertising Web page on its Web browser screen, the voice humor server transmits the specific voice humor to the Internet user's computer, and the voice humor is outputted through speakers while the advertising Web page is displayed on the Web browser screen of the Internet user's computer.

16. An Internet advertising system connected with voice humor services, the system comprising:
a voice humor server for providing a file having a combination of voice humor and an advertisement image;
an arbitrary server for providing humor link information for access to the file; and
an Internet user's computer connected to the voice humor server and the arbitrary server via the Internet;
whereby, if the Internet user's computer requests the file through the humor link information in the arbitrary server, the voice humor server transmits the file to the Internet user's computer, and if the file is received by the Internet user's computer, the voice humor included in the file is outputted through speakers while the advertisement image included in the file is displayed on a window of a player having a function of reproducing the file, and the file is not an advertising Web page connected to voice humor.

17. An Internet advertising system connected with voice humor services, the system comprising:
a voice humor server for providing voice humor;
an advertising server for transmitting an advertising Web page in which specific voice humor stored in the voice humor server has been inserted via E-mail; and
a recipient's computer connected to the voice humor server and the advertising server via the Internet;
whereby, if the recipient's computer requests the voice humor server to transmit the specific voice humor inserted in the advertising Web page, while displaying an advertisement image included in the advertising Web page mail transmitted from the advertising server, the voice humor server transmits the specific voice humor to the recipient's computer, and the specific voice humor is outputted through speakers while the advertisement image of the advertising Web page is displayed in the recipient's computer.
